(19) United States
(12) Patent Application Publication
(10) Pub. No.: US 2001/0038184 A1
(43) Pub. Date: Nov. 8, 2001

(54) Mounting device for securing a frame onto a snow board

(76) Inventor: Jamie Stafford, Rossland (CA)

Correspondence Address: SWABEY OGILVY RENAULT, SUITE 1600, 1981 MCGILL COLLEGE AVENUE, MONTREAL, QC, H3A2Y3, CA

(21) Appl. No.: 09/813,006

(22) Filed: Mar. 21, 2001

Related U.S. Application Data
(63) Continuation of application No. 09/213,771, filed on Dec. 17, 1998, now abandoned.

(30) Foreign Application Priority Data
Dec. 17, 1997 (CA) 2 225 133

(51) Int. Cl. B62B 9/04; A62B 9/04

(52) U.S. Cl. 280/14.27; 280/845

(57) ABSTRACT

A mounting device for supporting a frame, for instance of a snow bike or snow scooter, on a snowboard or the like comprises spaced apart front and rear supports for connection to the snowboard, a linkage mechanism for connection to the frame and to first and second locations respectively of the front and rear supports, and a displacement mechanism on at least one of the front and rear supports for allowing at least one of the first and second locations to displace relative to a respective one of the front and rear supports when the snowboard flexes thereby allowing a portion of the snowboard located between the front and rear supports to flex.

### RELATED APPLICATION

This application is a Continuation of U.S. patent application Ser. No. 09/213,771 filed on Dec. 17, 1998.

### BACKGROUND OF THE INVENTION

1. Field of the Invention

The present invention relates to downhill snow vehicles and, more particularly, to a mounting device for securing a frame onto a snowboard or the like.

2. Description of the Prior Art

“Dynamic performance” of a snowboard or ski refers to an advanced level “carving” turn in which the board's edges slice though the snow radially as opposed to skidding and sliding across it. In order for a snowboard or ski to perform dynamically, there are several factors that need to be considered, some of which are predetermined by its construction. Both snowboards and skis share similar constructions and built into each are sidecuts, stiffness, camber, metal edges, and varying flex patterns.

When a snowboard is under way and put on edge, the sidecut of the board takes effect when the pressure against the snow arcs (flexes) the board against its camber. The board's forward motion together with sharp edges and properly applied pressure control slices the board through the snow along a single radius produced by the flexing of the board, creating large “C”-type turns.

U.S. Pat. No. 5,351,975 issued on Oct. 4, 1994 to Petoud discloses a snow vehicle carried onto aligned skis and, more particularly, on a fixed rear ski on which the user stands and a movable front ski which is steerable by a handle bar assembly pivotally attached to the frame of the vehicle. The steering column is pivotally attached at three fixed locations to the front ski. The rear ski is attached to the frame by a pair of curved stringers which run along the upper side of the rear ski and are attached thereto. A foot rest is mounted onto the stringers. Cross braces extend transversally of the ski to connect the stringers and thus ensure a good rigidity of the hole unit.

Taking into consideration the sports of skiing and snowboarding, in order for the snowbike to perform dynamically, it is essential that its boards be able to flex underneath the bike along a single radius of curvature. In the aforementioned U.S. patent, the rear ski cannot flex where pressure is applied by the user's foot as rigid stingers are fixedly connected to the rear ski along most of the length thereof and especially under the user's foot.

### SUMMARY OF THE INVENTION

It is therefore an aim of the present invention to provide a novel mounting system for securing a frame of a snow bike or the like onto a snowboard.

It is also an aim of the present invention to provide a mounting system attached at least two spaced locations on the snowboard and provided with relative displacement means for allowing the snowboard to flex between the aforementioned locations.

Therefore, in accordance with the present invention, there is provided a mounting device for mounting a frame on a supporting article adapted to displace on a support surface, comprising spaced apart front and rear support means for connection to the supporting article, mount means for connection to the frame and to first and second locations respectively of said front and rear support means, displacement means being provided at at least one of said front and rear support means for allowing at least one of said first and second locations to displace relative to a respective one of said front and rear support means when the supporting article flexes thereby allowing a portion of the supporting article located between said front and rear support means to flex.

Also in accordance with the present invention, there is provided a mounting device for mounting a frame on a supporting article adapted to displace on a support surface, comprising spaced apart front and rear support means for connection to the supporting article, mount means for connection to the frame and to first and second locations respectively of said front and rear support means, displacement means being provided in said mount means for allowing said first and second locations to displace relative to each other when the supporting article flexes thereby allowing a portion of the supporting article located between said front and rear support means to flex.

Further in accordance with the present invention, there is provided a vehicle for displacing on a support surface, comprising a frame and a support member provided with front and rear support means, said frame being connected to said support member at first and second locations respectively of said front and rear support means, wherein at least one of said first and second locations being adapted to displace relative to a respective one of said front and rear support means when said support member is caused to flex thereby allowing a portion of said support member located between said front and rear support means to flex.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is a schematic elevational view of a snow bike or snow scooter having a frame thereof secured to a rear snowboard using a mounting device in accordance with the present invention;

FIG. 2 is a rear perspective view of the mounting device of FIG. 1;

FIG. 3 is a perspective view of the mounting device of FIG. 1 mounted to the rear snowboard;

FIG. 3a is an elevational view of the mounting device and rear snowboard wherein the rear snowboard is in an at rest position thereof; and

FIG. 3b is an elevational view of the mounting device and snowboard wherein the rear snowboard is in a flexed position thereof.

### DESCRIPTION OF THE PREFERRED EMBODIMENTS

For use on a downhill snow vehicle that has a frame and which is typically mounted on two in-line snowboards (e.g. snowbike, snow scooter), a mounting device D in accordance with the present invention allows one or more of the in-line snowboards to flex uniformly along its length while on edge and under pressure, thus allowing the board to carve dynamically throughout its turns.

The mounting device D is adapted for securing a frame F of a snow bicycle, snow scooter, or the like, to a rear ski or snowboard R. In the illustrated embodiment, the frame F includes a steering mechanism M connected to a front ski or snowboard S. Therefore, the present mounting device D provides a novel system for connecting the frame F to the rear snowboard R.

The mounting device D of the present invention has a wide base which spreads out the weight distribution to the rear snowboard R, making it less prone to breakage at the point of attachment. The device D allows the rear snowboard R to flex uniformly underneath the rigid mount for reasons which become apparent in the following detailed description.

The mounting device D is fixed centrally to the rear snowboard R in such a way that it remains rigid laterally, yet allows the snowboard R to flex uniformly along its length. Such a lateral rigidity ensure quick edge-to-edge performance, whereas the lengthwise arcing means that the snowboard R is able to carve dynamically throughout its turns.

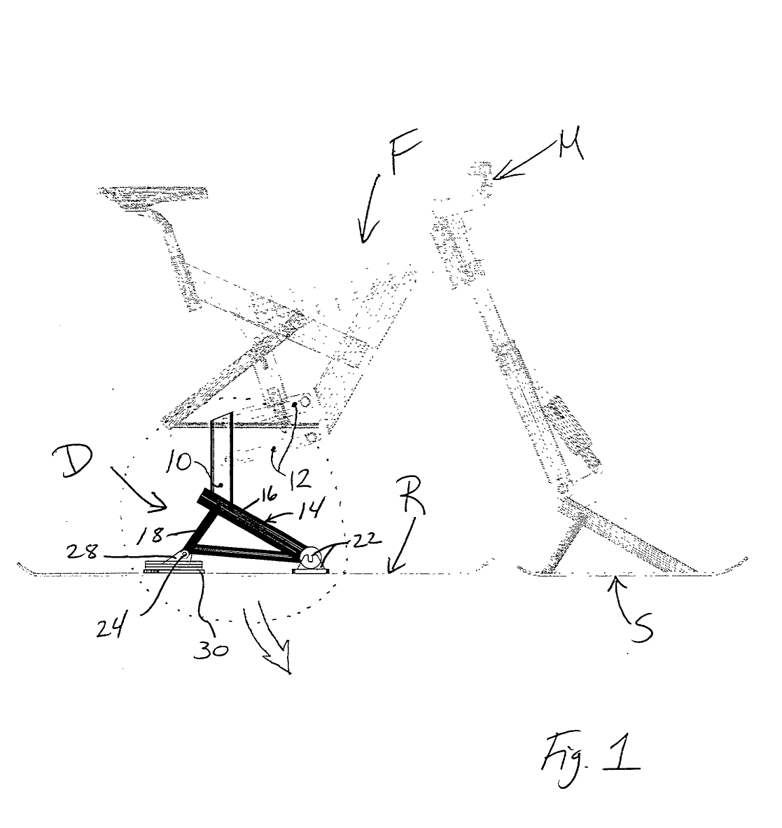

The mounting device D comprises a vertical mount 10 attached to the frame F of the bike, either via suspension arms 12 or, if it is a rigid frame F, to the frame F itself (see FIG. 1). The mount 10 extends downwardly to a tripod-like structure 14, with the longer of its arms 16 extending angularly downward and forwardly from a lower end of the mount 10 and with the two shorter ones 18 and 20 extending aft. At the end of each of these arms 16, 18 and 20 is a point of attachment, that is attachments 22, 24 and 26, respectively. These three points of attachment 22, 24, and 26 between the rigid mount 10 and the rear snowboard R contribute to the flexibility of the snowboard R.

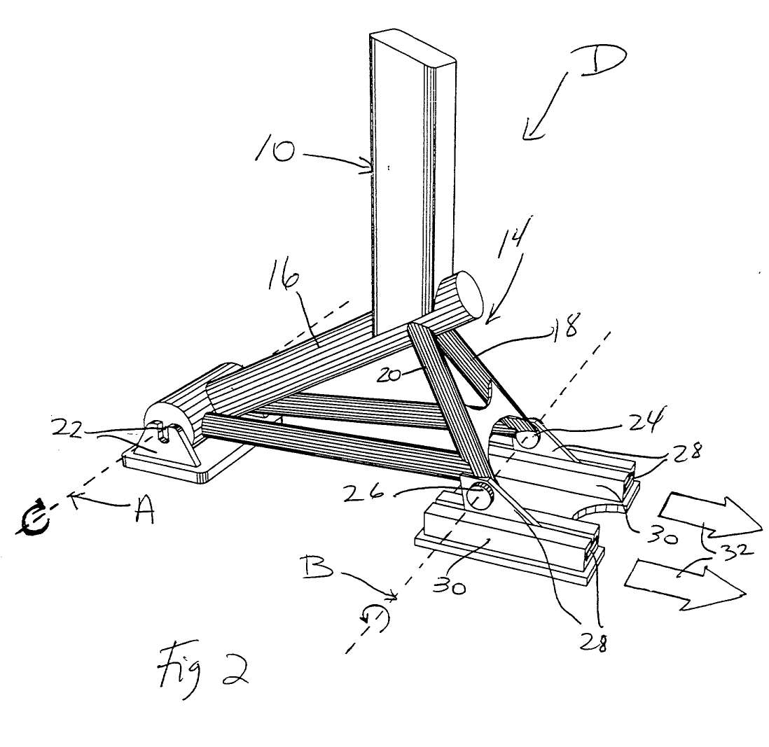

The front point of attachment 22 pivots about pivotal axis “A” (see FIG. 2), a horizontal pivotal axis perpendicular to the length of the snowboard R; i.e. the snowboard R can pivot about this axis “A” (along its length), but remains rigid in any other direction.

The two rear points of attachment 24 and 26 are each attached to a sliding mechanism 28 that slides in fore and aft directions within a guide or binding 30 attached to the rear snowboard R (rigid in any other direction), and able to pivot about an axis “B” (parallel to pivotal axis “A”) as the snowboard R arcs underneath it.

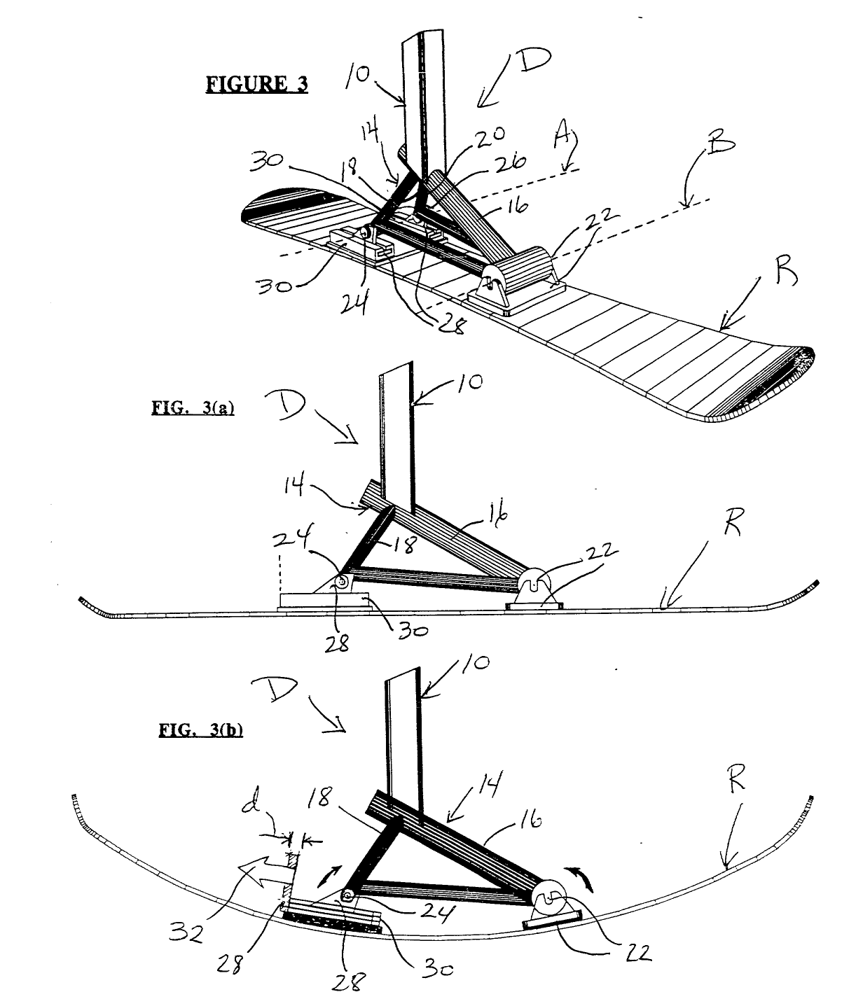

FIG. 3 shows that, as the rear snowboard R begins to flex, the front point of attachment 22 pivots about axis “A”, and the rear points of attachment 24 and 26 pivot about axis “B” and slide back a distance “d” along arrow 32 (see FIG. 3b) to compensate for the change in linear distance (between front 22 and rear 24 and 26 points of attachment on the snowboard R) as the rear snowboard R flexes.

Other possibilities embodying the present invention would include:

having the mounting device provided with rear pivots 24 and 26 which are fixedly fastened to the snowboard R while the front pivot 22 pivots and slides using a system which, for instance, could be similar to the sliding mechanism 28 and the binding 30; or

providing a mounting device where both areas 22, 24 and 26 pivot and slide, as long as the mount's fixed base allows the snowboard R to flex underneath its two areas of attachment.

Also, it is readily understood that the present frame F in the form of a snow bike can be replaced by other appropriate structures, such as snow scooter, etc. Furthermore, the present mounting device D could be embodied in certain applications on any snowboard or ski, front and/or rear.

The frame F can also be directly connected to front and rear attachments 22 and 24, that is without the mount 10 and/or the tripod-like structure 14. The main aspect of the present invention that must be present is the possible relative displacement between the front and rear attachments 22 and 24 with respect to the snowboard R (or the like) onto which these attachments 22 and 24 are mounted such as to allow the snowboard to flex between these attachment 22 and 24.

Therefore, the snow vehicle or the like is mounted to the snowboard at a pair of spaced locations, of which at least one typically includes a mechanism comprising preferably at least a pair of components capable of relative movement one with respect to the other, for instance using a slide mounted directly or indirectly to the vehicle's frame and which may displace relative to a fixed guide mounted to the snowboard. In fact, at least one of the locations is typically “floating” such as to allow for a relative displacement thereof with respect to the snowboard, that is, in other words, for a relative displacement between the fixed parts of the snowboard R to which the pair of locations are connected thereby allowing the snowboard to flex.

I claim:

1. A mounting device for mounting a frame on a supporting article adapted to displace on a support surface, comprising spaced apart front and rear support means for connection to the supporting article, mount means for connection to the frame and to first and second locations respectively of said front and rear support means, displacement means being provided at at least one of said front and rear support means for allowing at least one of said first and second locations to displace relative to a respective one of said front and rear support means when the supporting article flexes thereby allowing a portion of the supporting article located between said front and rear support means to flex.

2. A mounting device as defined in claim 1, wherein said displacement means comprise cooperating slide means and guide means provided on one and the other of a displaceable one of said front and rear locations and a respective one of said front and rear support means.

3. A mounting device as defined in claim 2, wherein said slide means are provided at said displaceable one of said front and rear locations and are slidably engaged in said guide means provided at said respective one of said front and rear support means.

4. A mounting device as defined in claim 3, wherein said front location is fixed with respect to said front support means, said slide means being provided at said rear location and said guide means being provided at said rear support means, said rear location and said slide means being longitudinally displaceable relative to said front location.

5. A mounting device as defined in claim 2, wherein said mount means comprise a tripod-like arrangement of arms including a front arm pivotally connected at a lower end thereof to said front location and a pair of diverging rear arms pivotally connected at lower ends thereof each to a respective rear location.

6. A mounting device as defined in claim 5, wherein said front location is fixed with respect to said front support means, whereas each said rear location is displaceable longitudinally along said rear support means, slide means being provided at said rear location of each said rear arm and being slidably engaged in respective ones of said guide means provided at said rear support means.

7. A mounting device for mounting a frame on a supporting article adapted to displace on a support surface, comprising spaced apart front and rear support means for connection to the supporting article, mount means for connection to the frame and to first and second locations respectively of said front and rear support means, displacement means being provided in said mount means for allowing said first and second locations to displace relative to each other when the supporting article flexes thereby allowing a portion of the supporting article located between said front and rear support means to flex.

8. A mounting device as defined in claim 7, wherein said displacement means comprise cooperating slide means and guide means provided on one and the other of a displaceable one of said front and rear locations and a respective one of said front and rear support means.

9. A mounting device as defined in claim 8, wherein said slide means are provided at said displaceable one of said front and rear locations and are slidably engaged in said guide means provided at said respective one of said front and rear support means.

10. A mounting device as defined in claim 9, wherein said front location is fixed with respect to said front support means, said slide means being provided at said rear location and said guide means being provided at said rear support means, said rear location and said slide means being longitudinally displaceable relative to said front location.

11. A mounting device as defined in claim 8, wherein said mount means comprise a tripod-like arrangement of arms including a front arm pivotally connected at a lower end thereof to said front location and a pair of diverging rear arms pivotally connected at lower ends thereof each to a respective rear location.

12. A mounting device as defined in claim 11, wherein said front location is fixed with respect to said front support means, whereas each said rear location is displaceable longitudinally along said rear support means, slide means being provided at said rear location of each said rear arm and being slidably engaged in respective ones of said guide means provided at said rear support means.

13. A vehicle for displacing on a support surface, comprising a frame and a support member provided with front and rear support means, said frame being connected to said support member at first and second locations respectively of said front and rear support means, wherein at least one of said first and second locations being adapted to displace relative to a respective one of said front and rear support means when said support member is caused to flex thereby allowing a portion of said support member located between said front and rear support means to flex.

14. A vehicle as defined in claim 13, comprising cooperating slide means and guide means provided on one and the other of a displaceable one of said front and rear locations and a respective one of said front and rear support means.

15. A vehicle as defined in claim 14, wherein said slide means are provided at said displaceable one of said front and rear locations and are slidably engaged in said guide means provided at said respective one of said front and rear support means.

16. A vehicle as defined in claim 15, wherein said front location is fixed with respect to said front support means, said slide means being provided at said rear location and said guide means being provided at said rear support means, said rear location and said slide means being longitudinally displaceable relative to said front location.

17. A vehicle as defined in claim 14, wherein said frame comprise a tripod-like arrangement of arms including a front arm pivotally connected at a lower end thereof to said front location and a pair of diverging rear arms pivotally connected at lower ends thereof each to a respective rear location.

18. A vehicle as defined in claim 17, wherein said front location is fixed with respect to said front support means, whereas each said rear location is displaceable longitudinally along said rear support means, slide means being provided at said rear location of each said rear arm and being slidably engaged in respective ones of said guide means provided at said rear support means.
